(19) United States
(12) Patent Application Publication
(10) Pub. No.: US 2012/0215594 A1
(43) Pub. Date: Aug. 23, 2012

(54) SYSTEM AND METHOD FOR GPS LANE AND TOLL DETERMINATION AND ASSET POSITION MATCHING

(75) Inventor: Kelly Gravelle, Poway, CA (US)

(73) Assignee: AMTECH SYSTEMS, LLC, Albuquerque, NM (US)

(21) Appl. No.: 13/398,337

(22) Filed: Feb. 16, 2012

Related U.S. Application Data
(60) Provisional application No. 61/444,286, filed on Feb. 18, 2011.
(60) Provisional application No. 61/445,636, filed on Feb. 23, 2011.
(60) Provisional application No. 61/477,962, filed on Apr. 21, 2011.
(60) Provisional application No. 61/550,851, filed on Oct. 24, 2011.
(60) Provisional application No. 61/498,453, filed on Jun. 17, 2011.
(60) Provisional application No. 61/510,933, filed on Jul. 22, 2011.
(60) Provisional application No. 61/568,472, filed on Dec. 8, 2011.
(60) Provisional application No. 61/545,650, filed on Oct. 11, 2011.

(51) Int. Cl. G07B 15/00

(52) U.S. Cl. 705/13

(57) ABSTRACT

A system carried by a vehicle for computing tolls using a global position satellite (GPS) signal receiver, a communications link, and compact toll lane information provided by a service center. Toll lane information is organized by travel monitoring point. Data for each point includes a latitude and longitude coordinate and either lane shape information or a coordinate offset from a similar lane. A driver interface module is used in conjunction with the OBU to allow selection of occupancy and to display toll information to the driver to allow for use in HOT lanes and to support congestion pricing models with zero or minimal infrastructure cost.

### CROSS-REFERENCE TO RELATED APPLICATIONS

This utility application claims the benefit under 35 U.S.C. §119(e) of provisional application Ser. No. 61/444,286 filed on Feb. 18, 2011; 61/445,636 filed on Feb. 23, 2011; 61/477,962 filed on Apr. 21, 2011; 61/545,650 filed on Oct. 11, 2011; 61/550,851, filed on Oct. 24, 2011, and all entitled “System and Method for GPS Lane and Toll Determination”; Ser. No. 61/498,453 filed on Jun. 17, 2011 and 61/510,933 filed on Jun. 22, 2011, both entitled “System and Method for Driver Performance Tracking” and Ser. No. 61/568,472 filed on Dec. 8, 2011, entitled “System and Method for GPS Lane and Toll Determination and Asset Position Matching.” The entire disclosures of these provisional applications are included herein by reference.

### FIELD OF THE INVENTION

The invention relates generally to the field of vehicle tolling and particularly to tolling accomplished or computed using GPS. The invention also can be used to allow for effective matching of the position of two or more assets using GPS positioning.

### BACKGROUND

Systems for electronic tolling and tracking of vehicles bearing RFID transponders is well known in the art. Generally these systems require fixed position reader installations with gantry-mounted antennas and substantial support equipment to coordinate readers and transfer vehicle information to a central service center. These systems require large up-front infrastructure costs and are thus, not very flexible when new tolling schemes are proposed or when new traffic patterns or legislation changes desired tolling points.

In addition, some tolling agencies offer preferred pricing to so-called “High Occupancy” vehicles. A toll price incentive and special traffic lanes are used to entice drivers to carpool and to discourage single occupant vehicle traffic. Conventional tolling systems are incapable of monitoring a high occupancy vehicle lane, since only fixed toll points can be checked for a tag designating the vehicle as high occupancy. Compliance on the roadway must be performed by manual inspection, which is expensive and can only provide minimal coverage.

The availability of inexpensive vehicle-based global position satellite (GPS) receivers opens the possibility of new forms of vehicle tolling and tracking. By determining vehicle position almost anywhere on a roadway, a GPS-based system can continuously monitor the vehicle's location and provide such functions as HOV lane compliance, congestion pricing and mileage based tolling with minimal infrastructure.

A U.S. Patent Application in this general area is publication number US 2011/0090075 A1, entitled “System and Method for Vehicle Performance Analysis” (Armitage, et al.,). All references cited herein are incorporated by reference.

### SUMMARY OF THE INVENTION

In an embodiment, the invention comprises a system for the collection of vehicle tolls by a tolling authority. The system includes an on-board unit having a GPS receiver; an a transceiver adapted to communicate with a common carrier. The GPS receiver establishes a location of the vehicle and the transceiver transmits the vehicle location to the tolling authority via the common carrier.

In a further embodiment, the system includes a user interface having a user input, wherein the user input is adapted to receive user data and the user data is transmitted to the tolling authority by the transceiver.

In a further embodiment, the system includes a user interface having a display, wherein the display receives information from the tolling authority via the transceiver

In a further embodiment, the system includes a user interface having a user input and a display wherein the user input is adapted to receive user data and the user data is transmitted to the tolling authority by the transceiver and the display receives information from the tolling authority via signals received by the transceiver. In a further embodiment, the interface is housed separately from the on-board unit, and the on-board unit is powered by the vehicle whereas the user interface is not powered by the vehicle. In a further embodiment, the interface communicates with the on-board unit wirelessly. In a further embodiment. the user interface is a smart phone. In a further embodiment the transceiver receives data sent by the tolling authority when the vehicle is approaching an upcoming toll threshold, and the data includes a toll cost to be levied upon crossing the toll threshold and the toll cost is displayed on the user interface display. In a further embodiment, the transceiver transmits to the tolling authority a unique identifier. In a further embodiment, the unique identifier is linked to a vehicle license plate number or a vehicle identification number (VIN). In a further embodiment, the system has a second transmitter, the second transmitter, which transmits a vehicle license plate number or VIN.

In a further embodiment, the invention comprises a system for the collection of roadway tolls by a tolling authority for vehicle traveling along a toll road. The system includes: an on-board unit having a GPS receiver; and a user interface. The user interface has a user input; a display; and a transceiver adapted to communicate with a common carrier. The GPS receiver establishes a location of the vehicle and the transceiver transmits the vehicle location to the tolling authority via the common carrier. In a further embodiment, the user interface comprises a smart phone and the smart phone communicates with the GPS receiver wirelessly to receive the vehicle location. In a further embodiment, the display is separate from the smart phone and the smart phone transmits information to the display wirelessly.

In a further embodiment, the invention comprises a method for collecting roadway tolls for a vehicle traveling along a designated portion of roadway. The method includes the steps of: computing a vehicle location from GPS data; transmitting the vehicle location and user identification data to a tolling authority via a common carrier; and assessing a toll charge for the vehicle based on the vehicle location. In a further embodiment, the method includes transmitting a vehicle occupancy level to the tolling authority; and assessing the toll charge based on the vehicle location and the occupancy level. In a further embodiment, the method includes: transmitting to an in-vehicle display a projected toll charge includes: transmitting from the vehicle a license plate number over a local wireless link; receiving the license plate number; and comparing the received license plate number with a visually observed license plate number. In a further embodiment, the method includes: storing a plurality of vehicle locations and transmitting the plurality of stored vehicle locations at one time to the tolling authority.

### DESCRIPTION OF THE DRAWINGS

FIG. 1 is a flow diagram of a preferred exemplary embodiment of the inventive method.

FIG. 2 is a plan view of a section of highway 200 over which certain data is overlaid to illustrate the contents of the database used by an OBU for purposes of the invention.

FIG. 3 is a schematic diagram of the vehicle and service center equipment used by the toll computation system.

FIG. 4 is a drawing of an exemplary embodiment of a driver interface module.

FIG. 5 is a drawing of an exemplary OBU.

FIG. 6 is a block diagram showing the overall architecture of an exemplary system along with support for more than a single application.

FIG. 7 is a flow diagram of a further exemplary embodiment of the inventive method.

### DESCRIPTION OF THE PREFERRED EMBODIMENT OF THE INVENTION

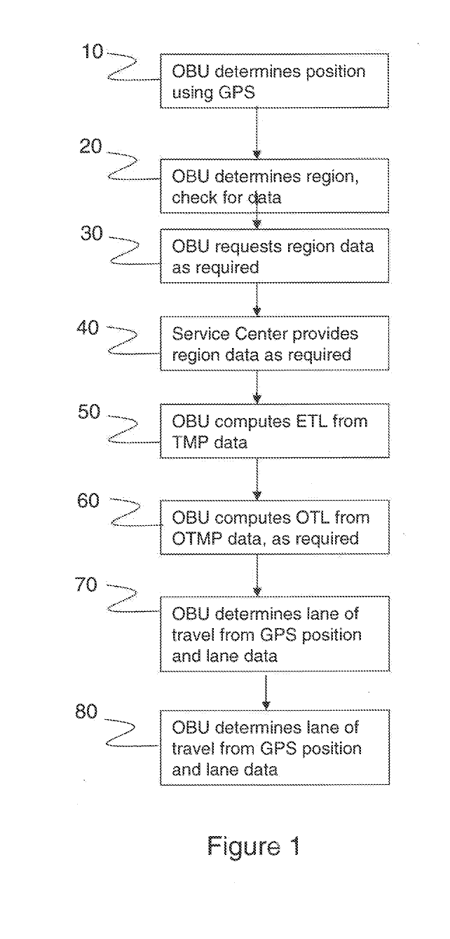

Referring to FIG. 1, in step 10 an onboard unit (OBU) carried by a vehicle determines its geographic position using a global positioning satellite system (GPS) receiver. Next, in step 20, the OBU determines the region in which the vehicle is located, and checks to see whether it has necessary data in memory to compute tolls in that region. In step 30, if the OBU determines that its data for the region is somehow deficient (e.g., incomplete or not current) then it requests data for the region from a service center. If required, the service center responds by transmitting the needed data in step 40.

Note that these steps illustrate just one of many equivalent ways of implementing the inventive method. For example, in place of steps 20-40, the OBU could periodically transmit its location and/or its identity to a regional, national, or global service center, and the service center could then respond according to its records with whatever data a vehicle with those latitude and longitude coordinates might require. Alternatively, the service center could even provide a highly detailed digital map of the region including all toll and non-toll roadways. However, a major goal of the invention is to minimize communications between vehicles and service centers. Steps 20-40 minimize communications by avoiding unnecessary requests from the vehicle.

In step 50 the OBU uses the compact travel monitoring point (TMP) data provided by the service center to compute an expected travel lane of travel (ETL) for each TMP. More accurate toll computations can be made by comparing the GPS positions of the vehicle to a path of expected positions for a particular toll lane than by comparing it to a single point. Comparison to a prescribed path is less susceptible to errors caused by receiver offset, temporary loss of GPS signal by the receiver, reflections, and other sources of GPS error.

Multiple GPS data points are sampled when the vehicle is proximate to an ETL (as many as possible) so that the OBU can compare these multiple points to an ETL in an effort to average out errors in determining whether it is likely that the equipped vehicle actually traversed the ETL. In an embodiment, the deviations from each GPS fix to the ETL are added together. Deviation is defined as the distance from the GPS fix to the closest point on the ETL. One direction perpendicular to the line is considered positive, the other negative. The ETL is considered traversed if the absolute value of the total deviation is below a threshold. In another embodiment, a least mean squared comparison is calculated and a determination made whether it is below a threshold. Typically, an exemplary algorithm will throw out extremes of the data, for exmple, one or more points, to eliminate the effect of outliers.

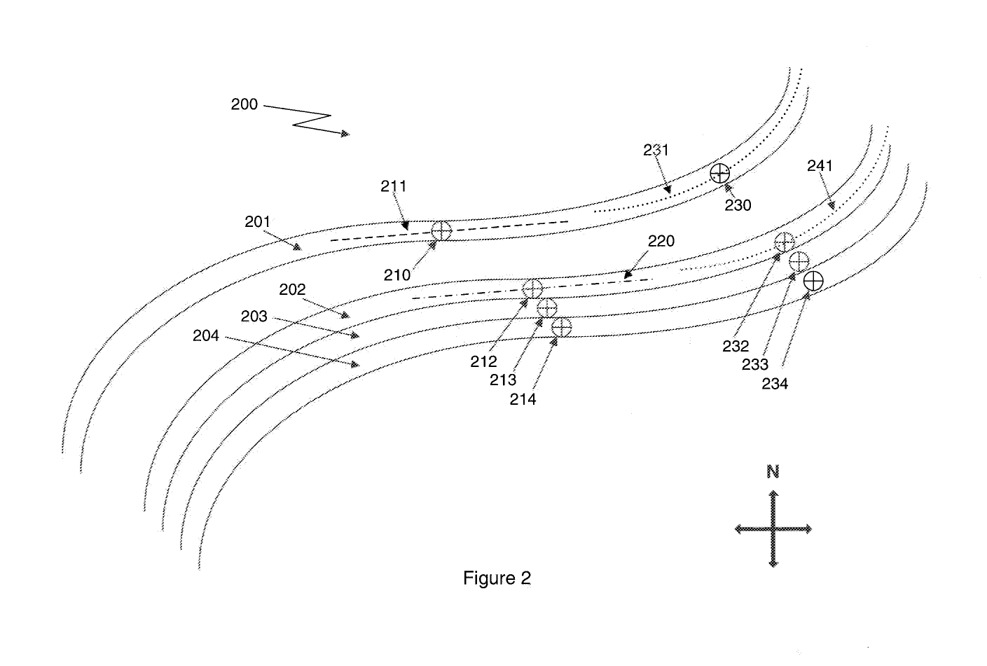

As will be discussed below in reference to FIG. 2, ETLs can be of any shape. However, for the sake of efficient communications between the vehicle and the service center, ETLs are preferably shapes which can be described with just a few parameters, e.g., a straight line or parabolic curve.

In step 60, the OBU computes an offset travel lane (OTL) from the data for each offset travel monitoring point (OTMP) provided by the service center. An OTL is just an ETL computed in a different way. Since many travel highway travel lanes are parallel to each other, once the shape of a first lane has been established, lanes parallel to the first can be described by simply giving the coordinate of the starting point of the first lane and the longitude and latitude offset for the starting point of each of the lanes parallel to the first lane.

In step 70, the OBU uses data from its GPS receiver and the computed travel lanes to determine in which lanes the vehicle is traveling. In step 80 the OBU determines what toll is therefore expected.

FIG. 2 depicts a section of highway 200 and exemplary associated database information. There are four lanes of traffic 201-204. Traffic monitoring point (TMP) 210 is at a particular latitude and longitude and has an associated expected travel lane (ETL) 211 which is a straight line. Offset lane points (OLPs) 212-214 could be described in the database simply by the delta latitude and longitude of their position relative to TMP 210. OLP 212 is shown to have an ETL 220 equivalent to that of TMP 210. The length and directions of the two ETLs are the same. The ETL 220 is merely translated in latitude and longitude from that of ETL 211 exactly as OLP 212 is translated from TMP 210. Similar ETLs (not shown) may be computed for offset travel monitoring points 213 and 214.

Determining the exact lane used by the vehicle may be significant. For example, lane 201 might be a high-occupancy vehicle lane for which the toll is different from ordinary traffic lanes 202-204.

TMP 230 has an ETL 231 which is a parabolic curve. As will be appreciated in the known mathematical, geometric, and computational arts, curves in two dimensional space may be described parametrically in any of several different ways. For instance, a simple curve can be described as a direction, an arc length, and a curvature. The same curve could be given in a certain range by the coefficients of powered terms (y=ax+bx2+cx3 . . . etc.). OLPs 232-234 could be described in the database by the delta latitude and longitude of their position relative to travel monitoring point 230. Associated with traffic monitoring point 232 is ETL 241, which is equivalent to ETL 231, but geographically offset from ETL 231 just as OPL 232 is offset from TMP 230.

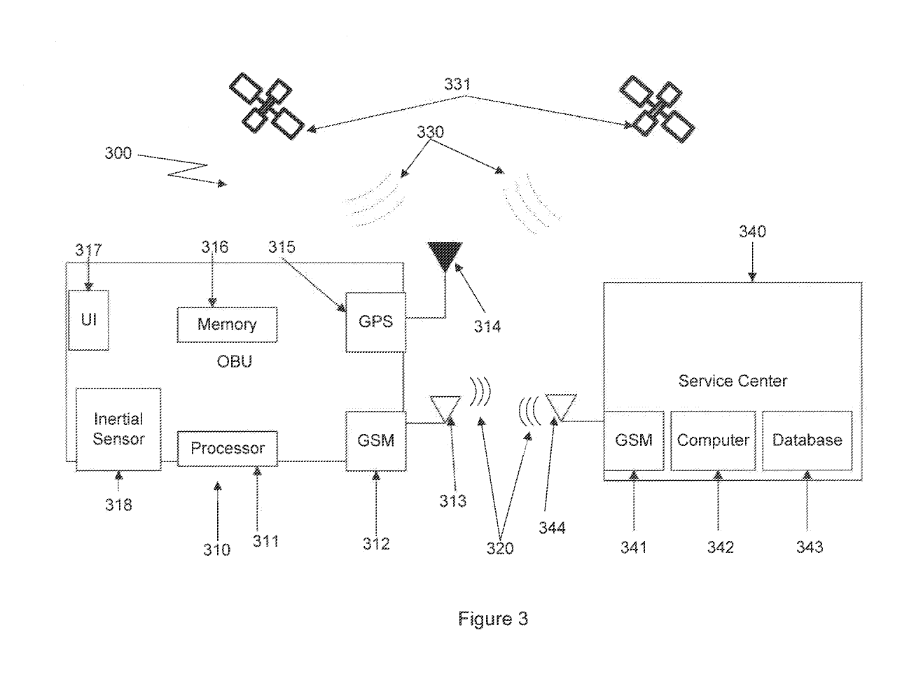

FIG. 3 shows the vehicle and service center equipment used by the toll computation system 300. The onboard unit (OBU) 310 is carried by a vehicle (not shown.) The OBU 300 includes a GPS receiver 315, which receives GPS signals 330 from GPS satellites 331. From these signals, the GPS receiver 315 determines the latitude and longitude coordinates of the geographic position of the receiver, and therefore of the vehicle. In practice, the GPS receiver 315 and other OBU components need not be incorporated into the OBU 310 as shown, but in an embodiment, can be carried by the vehicle externally to the OBU and in communication with at least one other OBU component as may be required to perform the functions herein described.

An alternative approach to the ETL/OTL approaches is to set up delimiter zones which are monitored by the OBU. A TMP could for example be defined by a free form polygon consisting of a set of points. After each position fix the OBU checks to see if the GPS fix point is within the boundaries of the free form polygon, and if so declares that the vehicle has traversed the TMP. To get the benefit of averaging, an alternative approach is as follows. After an initial GPS fix establishes a position within the boundaries of the polygon defining the TMP, the OBU takes a minimum sample size (SS) of GPS fixes. It is desirable that the sample size should be as large as possible, so this will typically be set based on the time the vehicle is expected to remain in the TMP. Determination of whether the vehicle is in the TMP can simply be by threshold percentage of the number of samples taken within the TMP defining polygon. For example if 20 samples are taken (SS=20), and the threshold for determining traversing the TMP is 75%, the TMP will be determined to have been traversed if at least 15 of the 20 GPS fix samples are determined to be inside the TMP defining polygon.

The OBU 310 contains a digital computing apparatus including a processor 311, which may be any kind of microcontroller, microprocessor, programmable logic device, etc., and memory 316, which contains space for data and/or instruction codes that may be required by the processor 311.

The OBU 310 is adapted to communicate with service center 340. For purposes of illustration, The OBU communication link 312 and service center communication link 341 are depicted as Groupe Special Mobile (GSM) transceivers with respective antennas 313 and 344 communicating using cellular telephone radio signals 320. In practice, a communications link may be established between the OBU 310 and service center 340 in any number of ways. The service center 340 may simply be connected to a regional telephone company. The OBU 310 may either use a GSM link 312, as depicted, or any other wireless means to connect to a telephone or data communications network, such as but not limited to direct private radio channels and satellite modems.

Via the communications links, the OBU 310 obtains regional travel monitoring point and related data from the database 343 located at the service center as controlled by the service center computer 342. The OBU 310 stores this data in memory 316. The OBU processor 311 then uses this data to compute expected travel lanes, which in turn is used in combination with GPS receiver 315 data to compute the expected tolls.

On occasion, GPS signals 330 may be blocked or distorted in a manner that prevents proper functioning of GPS receiver 315. This may occur, for instance, in mountainous terrain or in urban “canyons” where skyscrapers affect the receipt of GPS signals 330 at ground or sea level. At such times it is particularly beneficial for the OBU 310 to include an optional inertial sensor 318, such as a micro-electromechanical system (MEMS) accelerometer or gyroscope. Using such a device, the processor 310 may be able to infer the current position of the vehicle from a past GPS coordinate.

The OBU 310 also optionally contains a user interface (UI) 317. User interfaces can be quite complex, including such features (not shown) as a visual display or lights, speakers or audio indicators, keypads or manual input devices, a printer output, or a link to a personal computing or communications device. The UI 317 could also be as simple as, for example, a set of “nomination” switches (not shown) by which a vehicle occupant inputs to the OBU 310 the number of occupants of the vehicle for the purposes of computing a toll discount for ride sharing.

In an embodiment, the OBU is interfaced to an on board diagnostic port (OBD) on the vehicle. At a minimum this interface provides power to the OBU and gives the OBU access to the Vehicle Identification Number VIN to ensure that the toll is being collected for the right vehicle/account. Additional data sent to the OBU from the vehicle ODB can include: vehicle speed, odometer reading, outside air temperature, windshield wiper status, headlight and other indicator light status and the like.

An on board unit (OBU) is installed in a tolled vehicle contains a GPS receiver and a common carrier communications module such as a GSM modem to communicate data to a service center server, and a processor and memory.

A service center will from time to time download Travel Monitoring Points (TMP) within the lane of interest appropriately coded using GPS coordinates. TMP data consists of the GPS coordinates, a vector direction, and a length. These monitoring points are downloaded based upon requests from the OBU for such data in a region based on the known location of the OBU determined by GPS fixes performed from time to time. TMP data is stored in OBU memory and collectively allows for the determination in the OBU of Expected Travel Lines (ETL) that correspond to the lane being monitored in the local vicinity of the current position of the OBU. Because the ETL can be determined from the TMP data (a GPS point coordinate, a direction (say in degrees from North) and a length, ETL descriptions are compact, requiring limited data transmission bandwidth and more efficient storage of ETL's in memory so a larger number of these can be stored given the memory available on the OBU

In order to improve the accuracy of determination of lane of travel, multiple GPS fixes can be taken when the OBU believes it is in the vicinity of an ETL. Individual GPS fixes may contain errors sufficient to cause incorrect determination of lane, but by taking multiple GPS fixes while in the vicinity of the ETL, multiple data points can be compared and fit to the ETL in the vicinity, thus averaging any errors that occur in individual GPS fixes. If an analysis of the multiple data points versus the ETL meets certain criteria, it can be concluded that the vehicle in which the OBU is installed is indeed in the travel lane. For example, one can calculate the average offset for each GPS fix vs the closest point on the ETL. If the magnitude of the sum of the total error of all the data points is less than a certain threshold, the OBU is determined to have traversed the ETL with a high degree of certainty. Other well known curve fitting techniques such as rejecting a small number of data outliers can also be used. Traversing the ETL establishes that the OBU and associated vehicle have crossed the TMP. This data is then used to determine that a toll payment is or is not due for travel upon the particular segment of road in the monitored travel lane.

It should be noted that other suitable mathematical functions than a line may be used to represent the expected travel trajectory of the vehicle within a lane or roadway, such as a parabola. The key concept is to be able to represent at least parts of the expected travel trajectory efficiently within memory so that the expected travel path can be compared to the actual GPS data at multiple points to take advantage of averaging to mitigate GPS errors, and thus make a much more accurate determination of the lane or roadway of travel of the vehicle.

This technique can be used in conjunction with a category determination algorithm within the OBU. The roadway and/or lane of travel are determined in conjunction with the technique described above. In addition to the data described above, a toll rate or toll rate category is downloaded with the other data and associated with the TMP's and/or identified roadways. Roadway determination can be done as described above for lane determination, but with thresholds suited to the size of the roadway and the potential for confusion with other non-tolled road facilities in the vicinity. The OBU then collects toll data and collects this information in memory for use in calculating the total toll or use charges later. For example, the OBU can either interface to the existing odometer or generate “virtual” odometer data by taking regular and relatively frequent GPS fixes to calculate the distance traveled by the vehicle by summing all of the individual distances between GPS fixes. In one embodiment the toll charge is calculated as a fixed rate with the mileage determined by the virtual odometer. For example if the toll rate is established at $1.00 per mile in the special use lane (for example a designated High Occupancy Toll (HOT) lane), but 0.50 a mile in the General Purpose Lanes, the proper toll is accumulated in the memory of the OBU, based upon which part of the roadway the user is driving on. Alternatively a fixed toll charge could be accumulated for each TMP that is traversed, or specific toll fees could be associated with each individual TMP and accumulated in memory as the vehicle passes each such point. This data is offloaded over the common carrier link at defined times to the service center so that it can be used to generate a settlement activity with the authorized user of the OBU in question. In addition, the driver may be able to declare a specific status used to calculate the toll charge, such as the vehicle occupancy. Policy makers frequently will allow High Occupancy Vehicles to use designated lanes for no or a lower charge, the user or driver can “nominate” his vehicle for such treatment by entering the data on the OBU, for example by using a nomination switch that sets the occupancy status for the purpose of toll calculation.

When Travel Monitoring Point and related data are downloaded from the service center, this data is sent with a time and date stamp and a region code. When an OBU enters a specific region, it provides the service center a report of the data contained in its memory including the region or regions retained and the date stamp. The service center can then determine whether the OBU has the correct data in its memory to collect the correct toll, based on the region(s) available and the date stamp(s). Therefore it only downloads new TMP data to the OBU if this is necessary, thus minimizing the data sent over the common carrier link to keep data charges as low as possible. However if the OBU data for the region in question is not available or outdated, this data is then downloaded to the OBU. For typical commuters who use the same regional roads frequently, these updates will be limited in frequency thus limiting the data usage. As commuters leave a defined region or a radius from a center point, the system can send need TMP's to the unit, and identify other TMP's for removal so that the memory available to store TMP's in the unit does not overflow. Alternatively, the unit can automatically decide which points to discard based on those that are furthest away, and the service center will do a parallel determination so it is keeping track of the points held by that unit. Points are numbered and serialized so that at any time the service center can compare the series set that is stored. For example if queried by the service center an OBU it can respond that it has the following series 300-423; 555-900; 875-1050; 1139-1300.

As an OBU moves beyond the border of a region, the service center will add TMP's and remove others (or allow them to be automatically removed as above) by sending coded messages to the OBU. These can consist of single points or groups or series of points. For example, a rule may be set where no updates are sent until 100 points should be updated in the OBU. These can then be transmitted as a single message with a series of the 100 points to be added and then the 100 to be removed. Further, as the OBU moves out of a defined region and exchanges TMP's, the sytem avoids the jitter that can occur when vehicles move in and out of a new region. In this situation a lot of TMP exchanges can occur as a vehicle crosses a border area between regions that demarks where TMP's should be exchanged. This could generate a lto of undesired data traffic on the network if the OBU is frequently in this “border” area. This effect can be minimized by designing hysteris into the logic so that a vehicle that travels out of a region a distance and start to exchange TMP's does not reverse the process of TMP updates upon a simple return to the border area but must come back into the region a specified distance before TMP's are exchanges in the reverse direction. Selection of a proper hysteris parameters either based on distance or the number of points to be exchanged will ensure data traffic is minimized even in border areas that are frequently crossed.

It is also possible that with the propoer amont of hysteresis in the system the idea of regions can be eliminated entirely. An alternate TMP update plan could be based on simply maintaining as amny of the points that can be held in memory that are closest to the current travel point subject to hysteresis over a certain distance or number of points.

The approach of comparing known Expected Travel Lines and Travel Monitoring Points with on board toll metering has the significant advantage that tolls can be determined without the need to send frequent GPS fixes to essentially track the vehicle at the service center. This again minimizes the amount of data traffic that must be sent over the common carrier link, and allows for users who are concerned about privacy to use the system without being continuously tracked.

Further, the invention can also include an RF transmitter to transmit data that identifies the vehicle such as the license plate number or the VIN. This data can then be received by either manual or automated toll or HOT enforcement systems to help eliminate vehicles that are operating with the GPS Toll device from further enforcement consideration on the basis that proper payment is assumed to have been received from the GPS Toll system. For example, in a Toll road application where video enforcement is used, the device broadcasts the license plate number over the RF link and is received at a roadside receiver, proximate to the video enforcement system. This license plate data is time stamped. When the vehicle passes by the enforcement cameras, the video enforcement system will take a picture of the license plate of the vehicle. This photo will be analyzed using automatic plate reading software to generate an automated read of the license plate number and also time stamped. A computer can then be used to compare the automated plate reads to the plate numbers broadcast indicative of GPS Toll equipped vehicles received within a time window, such as 30 seconds. If they match, the automatic plate read can be removed from further enforcement consideration automatically, thus reducing the burden on the enforcement processing system that would otherwise be required.

The RF transmission of vehicle identification data can also be used in conjunction with a manual enforcement process. Currently, most HOT lane systems are enforced manually, as a police officer or other official must observe the occupancy status of the vehicle manually. In a HOT system, where the user only pays a toll if the vehicle occupancy is blow a threshold (or where the toll amount depends on the occupancy) the police officer must also observe if an authorized toll payment device is in the vehicle in addition to occupancy. While occupancy status is usually fairly easy for an officer to observe, the presence of the GPS Toll payment device may not be. Therefore, absent the transmitter feature officers may end up stopping a larger number of motorists who turn out to have a compliant device in the vehicle because the officer could not observe the device. If this number is too large, enforcement may become prohibitively expensive and inefficient, plus very inconvenient for motorists pulled over incorrectly.

However, with the use of a transmitter on the GPS toll device to transmit vehicle identification data and a corresponding receiver in the officer's vehicle or otherwise accessible to the officer, the officer can more easily filter out authorized GPS Toll users by matching the vehicle license plate to the locally transmitted set of authorized plates. In such a way the officers can be assured they will not stop vehicles that have properly authorized devices, rendering manual enforcement of HOT or any other toll, parking or other forms of payment for services, much more practical.

The RF transmitter will typically be a UHF transmitter permitted by FCC regulations. For example the transmitter could be a simple low power single frequency 915 MHZ transmitter using ASK modulation, as used in tags currently used by the Inter Agency Group (E-ZPass) in the Northeastern US. Other transmitters can be used such a low power UHF FSK transmitter, Frequency Hopping Spread Spectrum (FHSS) transmitter, or a Direct Sequence Spread Spectrum(DHSS) transmitter These are just examples of the types of transmitters that can be used and many others are known in the art. Typically, vehicle identification data will be encrypted so as to protect this data from eavesdropping and also to validate that the data comes from an authorized device and not a counterfeit or cloned device. Data encryption can employ well known encryption techniques such as the standard AES algorithm, or an asymmetric encryption algorithm such as RSA. In each case the chosed type of transmitter and encryption technique are used in conjunction with the correlating type of receiver for reading the data and decryption for decoding data.

The OBU device also optionally implements a two way low power UHF transceiver for bidirectional communication with a driver interface module (DIM) mounted at a location convenient to the driver in the vehicle. The implementation of a low power transceiver on both ends is implemented using off the shelf transceiver chips well known in the art. The OBU is typically powered by the vehicle and therefore turns on the transceiver a high percentage of the time (high duty cycle) so that it can receive a message over the UHF link from the dirver interface module at any time. The driver interface module is optimized for low power operation and designed to have a long life (several years) on commercially available batteries, therefore runs on a low duty cycle, sending a query message to the OBU relatively infrequently (say once every 5 seconds) so that the duty cycle of operatio can be kept low. If the OBU has a message for the DIM it then sends the message at that time, otherwise the DIM goes back to sleep. The DIM can also send messages to the OBU asynchronously at any time since the OBU receiver is operating at close to 100% duty cycle.

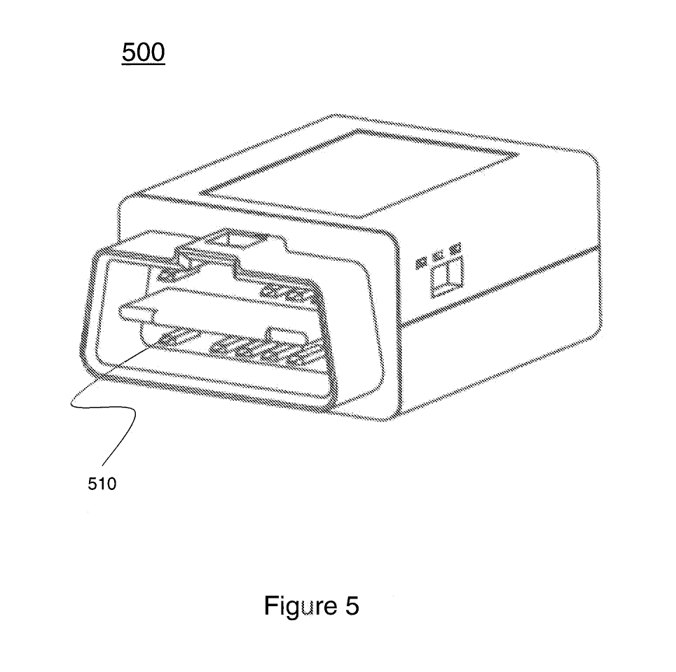

FIG. 5 shows an exemplary OBU 500 having contacts 510 for connection to the vehicle power supply and other signals, such as an on-board vehicle computer.

The DIM consists of a microcontroller, a transceiver chip, and supporting circuitry well known in the art and is battery powered. It also has an interface from the microcontroller to an LCD, Organic Light Emitting Diode (OLED) or any other type of display known in the art, an input button and a four position slide selector switch, and a piezo buzzer. The slide switch allows the user to select the occupancy nomination for the vehicle. A messaging protocol is set up to allow the DIM to communicate with the OBU. When the slide swich settings are changed on the DIM, the DIM will communicate the occupancy level to the OBU so this data can be included in the toll transaction data collected by the OBU and used to compute the proper toll. The positions of the slide switch designate occupancy of 1,2,3 or more people in each of 3 positions. A fourth position is used to communicate to the LMU tha the user wants to turn the toll collection function off completely.

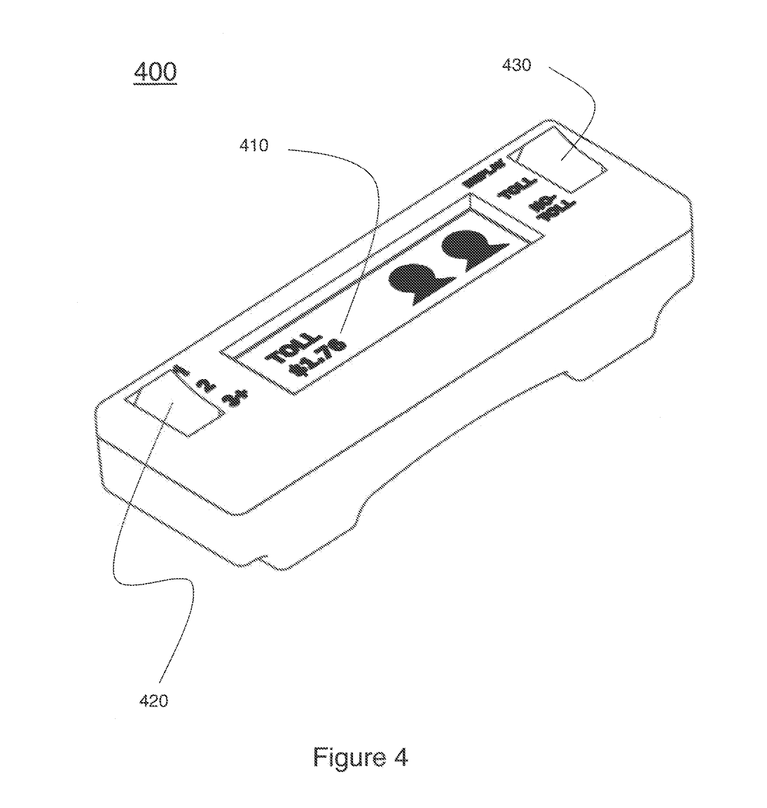

An embodiment of the DIM is shown in FIG. 4 The DIM 400 has an OLED display 410 and two three-position rocker switches 420, 430. One of these rocker switches 420 is used to select the nominated occupancy setting, which in this embodiment is shown as one, two or “three or more” occupants. The second rocker switch 430 is used to turn the tolling function on or off. The third position on the second rocker switch is a momentary switch position. Rocker switches have the advantage that the user can see the option selected by looking at the switch, and also that they can effectively be operated based on tactile feedback (i.e. by feel) and makes the device more user friendly and of minimum distraction to driving.

The toll on /off selection can be used if the user in driving proximate to a tolled lane or road, but is not in the tolled lane and wants to eliminate all possibility of being billed for an erroneous toll. In another embodiment, the non-presence of the DIM proximate to the OBU can be set to automatically disable collection of any tolls. This may be used by a driver who might, for example, loan his son the car, but not want him to be able to charge tolls. In this case the DIM can be removed from the vehicle and no tolls can be charged

The momentary position of the second rocker switch 430, when depressed for a short period, can activate a recall function of the last display of toll amount, or when depressed for an extended period can act as an on/off switch for the DIM. Other functions of the OBU can be enabled or disabled according to the desired configuration for the system. Another function of the DIM is to display the active toll rate to the driver so he or she can use this information to decide on whether to access the tolled facility or lane. This can be of particular importance when the system is used on a congestion pricing type of environment. The updated toll rate or applicable discount to a standard toll rate is broadcast for the application section of roadway and stored in the OBU. When the OBU determines that it is approaching a decision point, which is handled as a special case of a toll point in the OBU, it sends a message to the DIM on the next query message sent by the DIM. The message commands the DIM to display the upcoming toll amount and to send a configurable “beep” message letting the driver know toll info is being communicated. The OBU can also look at the time of day information it receives from the common carrier network, and decide whether the DIM display should be illuminated or back-lit as appropriate for the type of display. In this way the DIM preserves power by only displaying a backlit or illuminated message when necessary. The driver can always recall the last display message by pressing a push button or momentary rocker switch position on the DIM.

In an alternate embodiment of the DIM, the DIM incorporates a fingerprint reader (not shown) to record at least a single fingerprint of at least a single selected finger, for example the right index finger. The number of distinct fingerprints can be used to validate or provide the primary data input to determine the vehicle occupancy. Upon entering the vehicle and for safety before the start of operation, each of the occupants would swipe a fingerprint which would be stored temporarily for the duration of the trip in the memory of the DIM. At the conclusion of the trip (when engine is turned off as detected by the OBU) the occupants are prompted to swipe fingerprints again to validate that they made the trip, thus indirectly validating the occupancy of the vehicle during the trip and during use of the HOT or HOV lane.

It is known in the art that the OBU can sense engine on/off by looking for characteristic electrical changes (spikes) on the power rail when the vehicle is turned on or off, or alternatively by data provided over the OBD port from the vehicle computer or by direct sensing of the vehicle ignition. Alternatively, fingerprint information could be sent stored and compared in the OBU, or further transmitted over the GSM link to a back office server where it is stored and compared. Storing and comparing the fingerprint on the DIM has the advantage that the fingerprint is never sent or permanently stored, thus limiting any concern about potential privacy abuses resulting from the collection of a fingerprint, and also limiting the over-the-air bandwidth used and any associated common carrier costs to do so.

The DIM in combination with the OBU provides the user and public authorities a set of functions that are designed, when taken together, to provide a minimum to zero infrastructure option for tolling, HOT, and congestion pricing applications that would otherwise require deployment of infrastructure that is very expensive and typically requires a long period to be approved, financed and deployed.

As an alternative to DIM module, the functions of toll display, nomination, and on off functionality can be provided by a smart phone application. Such an application allows the user to nominate the vehicle's occupancy on the smart phone display. A large touchscreen button is programmed into the application to minimize any distraction to the driver who wishes to use the phone for nomination. Nomination is accomplished by taps. On tap is single occupancy, two taps double occupancy etc. Touching and holding the display for a fixed time, such as three seconds turns the toll function on or off, toggling from the last state. Alternatively, the display can be divided into two halfs, top and bottom, with a soft (touchscreen) button on each half. Holding one half for a time, say 3 seconds, turns on the toll function. Holding the other half the same period turns off the toll function. In this way the on/off and nomination data can be inputted by the driver by feel and with minimum distraction.

Once the nomination and toll collection status have been input to the phone by the user, the application will then connect to the server over the internet link to the service center to relay the data. The service center then uses this data (occupancy, toll service on or off) in addition to the data received from the OBU to calculate the proper toll charges. Alternatively, SMS data messages can be used to relay the required data. Either from the smart phone or any other phone that supports SMS messaging.

Another alternative embodiment with a smart phone application is to include the functionality of storing and matching the TMP's in the smart phone, and/or determining distance travelled in the smart phone application as well. In fact, all functions described as carried out by the OBU in the description above, can be implemented in a smart phone application by taking advantage of the common carrier data connectivity of the smart phone and the GPS location capability included in every smart phone. In this way the required toll functionality described in this application can reside completely on the smart phone, with the exception of the low power data radio link used to communicate outside the vehicle for the purpose of enforcement as described above. In order to address the enforcement issue, the OBU device can be modified to consist of a Blue Tooth® connection integrated with the low power wireless data connect described above. This will be a much lower cost OBU compared to the full function OBU, and allows use of the smart phone data connect which may be much lower data access cost than a dedicated data link from the OBU to the common carrier network. This approach connects, or marries, the smart phone to the vehicle via license plate data that is embedded in the OBU.

In addition to a local broadcast or two way communication of the license plate data to local machines for manual and automated enforcement coordination as described above, the encrypted license plate data can be communicated over the Bluetooth® link to the phone and then over the common carrier data link to the back office, so that the toll system can determine that the toll payment from the smart phone matches a particular vehicle, and any enforcement action such as processing a violation image can be negated at the back office. One disadvantage of this approach is that is that turning on GPS functionality on the smart phone will significantly reduce battery life because of the typically high current consumption of GPS modules. To mitigate this disadvantage, the OBU could also add a GPS receiver. Since the OBU is vehicle powered this does not impact smart phone battery life. GPS data is then relayed to the smart phone application over the Bluetooth® link to obtain the requisite GPS data to complete the toll collection process, but without the need to turn on the smart phone GPS, which increases current consumption and reduces the phone's battery life.

In addition, the OBU can be configured to send a message to the service center as the vehicle approaches a TMP. This message can then be used to prompt the service center to send a message to the smart phone via any available data link with the current toll charge so this can be displayed on the smart phone display. Each data entry or data display functions described for the smart phone application are accompanied by distinctive audible alerts so the driver has feedback on data entry and knows when to pay attention to the display when the upcoming toll charge is displayed.

One advantage of the system described herein to conventional toll collection using fixed infrastructure points (typically using Dedicated Short Range Communications (DSRC), Radio Frequency Identification (RFID), or License Plate Readers (LPR)) is the ability to easily select “virtual” toll points that can be located anywhere on the roadway. This provides a tremendous amount of flexibility for transportation planners and eliminates many limitations designers of toll facicilities encounter in setting up toll systems. In addition, this flexibility can be taken advantage of to maximize the accuracy of the GPS based toll function. GPS statistical accuracy may be better at some locations than others, due to various factors such as multi-path interference, RF interference, and the effective view of the sky (elevation angle at the various points around the compass) and therefore the constellation of GPS satellites that are likely to be received by the unit. Therefore, the precise physical point where the vehicle toll is collected (or position match made) can be selected specifically to be at a location where the statistical accuracy is better than another location. Further, these locations need not be static, the location that is used as an effective toll point can change based on factors such as the current GPS satellite configuration, or based on the type of installation (location in the vehicle) to maximize the accuracy of the toll collection determination. This can be accomplished either by dynamically downloading new TMP's as circumstances warrant, or by including data from toll points that are expected to have more accurate GPS data at that particular point in time and not including those that are expected to be less accurate at that particular point in time. Excess TMP's can be downloaded to the OBU to provide an excess number to allow for the fact that at certain points in time only some of the TMP's will contribute data to the toll collection process.

The accuracy of the GPS fixes at the toll points can be established by correlating the measured performance to certain configurations of the satellite constellation, or by dynamically measuring the accuracy of the GPS fix at the TMP's. This can be done by static monitors in or near the TMP's. These units will typically consist of a battery or wayside powered OBU and are placed at a known location proximate to the TMP's when the deviation from the known location at those TMP's exceeds a threshold, the corresponding TMP is not longer considered in the toll charge determination until the accuracy returns. Similarly TMP accuracy tests can be done by periodically driving test vehicles in a known lane and verifying that the OBU is reporting in the correct lane. If errors exceed a threshold for a period of time then data from that TMP is considered to be lower accuracy and is not considered in toll determination for that period of time.

Another approach that can be implemented is a master TMP that consists of several TMP's within a much larger TMP segment. For example a master TMP might consist of a section of road 2.5 KM long. This TMP segment is then broken up into 5 subsegments that are each 300 meters long. Each subsegment TMP is then evaluated on its own. Typically, the subsegments are selected where possible to give different views of the GPS satellite configuration. If the TMP processing algorithm determines that a certain threshold ratio of subsegment TMP's are traversed, then the entire segment is determined to have been traversed. For example in this case we might set the threshold to determine that 4 of the 5 300 meter subsegement TMP's have been traversed, and thus determine that the toll is due for traversing the associated master TMP segment.

Another alternative to determining the actual lane of travel is a minimal, rather than zero, infrastructure approach that involves mounting battery powered low power radio devices (not shown) in the median or other locations proximate to the lane of travel, that can communicate with the DIM and/or the OBU in the vehicle. Such devices are set with a radiation pattern directed towards the HOT lanes and monitored such that the peak signal strength expected to be received in vehicles within the monitored (HOT) lanes will be significantly higher than that received in vehicles in other lanes. By selecting a threshold in between these two expected peak values, the OBU or DIM can determine if the vehicle is actually in the monitored travel lane, thus providing a means to automatically charge tolls without the need for the driver to use the DIM to turn tolling on or off. It is well known in the art that such devices can be low cost and provided with batteries that will last several years, thus providing not only a minimal infrastructure solution but also a minimum maintenance solution to automatic identification of the HOT lane in cases where GPS accuracy and repeatability are not sufficient to achieve acceptable automatic lane determination.

In addition to the toll applications described herein, another application of the OBU on the vehicle with a low power radio data connect is to determine when two pieces of mobile equipment, such as a tractor and a trailer are in proximity to each other with a minimum of data utilization. One possible approach is to continually track each piece of mobile equipment using GPS monitoring over a common carrier network, and set up a back office function to determine, by comparing GPS fix data, when the two pieces are in sufficient proximity to each other and sending out an alert. However, this approach has the disadvantage that frequent GPS data points need to be sent over the common carrier network, increasing data utilization costs.

An alternative approach is to use the low power UHF data connect on the OBU to probe by sending a connect message to see if another piece of OBU-equipmet is within range of the first piece of equipment. If a connection is established over the low power radio link, it is assumed that the two pieces of equipment are generally proximate to each other. To further refine this proximity measurement, the two OBU's share GPS data over the low power data radio link and either or both OBU's can compare the location of the proximate unit's GPS coordinates to its own. When such coordinates are compared and found to be within an adjustable threshold, an alert message is sent indicating that the mobile equipment pieces are in proximity. If the low power link is later broken or GPS comparison shows they are no longer proximate, in accordance with the defined configurable threshold, an alert can also be sent. In this way, proximate location can be determined simply by sending event-driven messages when the proximate status changes and without sending frequent messages to track the mobile equipment pieces on an ongoing basis, and therefore at much lower data communications cost.

This technique can also be used in enforcement. In this case the encrypted license plate number and the GPS coordinates are sent over the low power radio data link, and the enforcement module is equipped with transceiver and a GPS receiver similar to an OBU. Comparison of the GPS data received the enforcement module with the enforcement module's own GPS data provides further enhancement in determining the relative positions of the enforcement module and the vehicle. Enforcement officers can set an offset position for the vehicles they would like to see data displayed for. For example an officer who wants to observe from the left median may set an offset position of 3 m+/−2 m to the right and 4 m in front, with the idea of observing a vehicle plate as the vehicle passes. In this way the enforcement system will display the license plate number, occupancy status, and payment status of a vehicle precisely where the officer is set up to observe it, making enforcement activity easier.

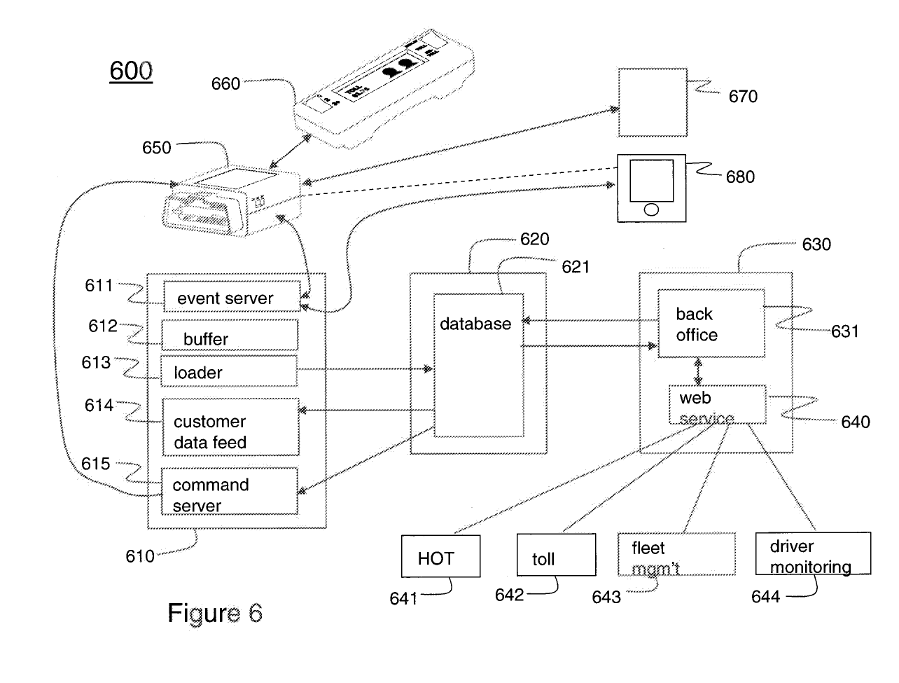

FIG. 6 is a block diagram of an exemplary system 600 for low-overhead toll collection with a GPS enabled OBU 650. The system comprises an OBU 650 such as described above. The OBU communicates with a message server 610, which comprises an event server 611, event buffer 612, data loader 613, customer data feed 614 and command server 615. The command server sends commands to the OBU while the event server handles real time event data, such as the crossing of a TMP or a driver nomination. The links between the OBU 650 and the message server 610 are wireless and can be over an existing GSM communications system, for example. Vehicle location data is sent from the OBU 650 to the message server 610, which then loads the information to a database server 620 having a database 621. The vehicle position data (which may be in the form of TMPs traversed), is accessed by the application server 630, which handles back office processing 631 of the data to properly bill the customer. The application server may interface via the web via web service layer 640 and enable applications such as HOT 640, toll, 642, fleet management 643, and driver monitoring 644. Each of these applications can use the vehicle position information gathered by the OBU for their individual functions.

The OBU 650 communicates with the DIM 660 via a wireless link as described above. The OBU can be connected to an enforcement module 670. The enforcement module 670, as described above, can be used by law enforcement to query the OBU to confirm whether the license place of the vehicle carrying the OBU matches the OBU and whether the number of occupants in the vehicle matches the number claimed by the OBU setting. The interface between the OBU and the enforcement module can be a USB interface, and the enforcement module can plug into a USB port on the OBU, for example.

In a further embodiment, the OBU 650 communicates with a smart phone 680 instead of a DIM. That communication would be over an optional Bluetooth® wireless link. In an embodiment, the smart phone provides the wireless data connection back to the message server, making the OBU a less expensive product.

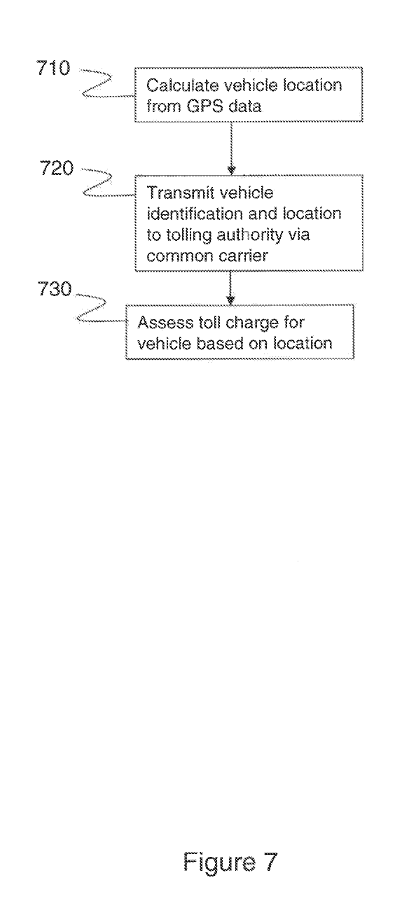

FIG. 7 is an exemplary flow diagram for a method of collecting roadway tolls for a vehicle traveling along a designated portion of roadway. At step 710 vehicle location is computed from GPS data. At step 720, vehicle location and user identification data is transmitted to a tolling authority via a common carrier. At step 730, a toll charge for the vehicle is assessed by the tolling authority based on the vehicle location.

In further embodiments, new methods of tracking drivers and providing economic incentives for good driving may be based on hardware which combines features of a driver report card and GPS lane and toll determination systems.

For example, conventional tolling, high-occupancy tolling (HOT), road pricing fee (i.e., toll charges varying with time of day, congestion, or other circumstances), or parking fee charged to the user can be adjusted to reflect the safety record of the driver(s) using that vehicle.

If the score on the report card is above a threshold after a period of time, a fixed discount can be awarded for tolls paid, either via conventional (existing) means of toll collection or collected via the GPS tolling solution of our provisional application. For example, if the score is above 85 for the month of August 2011 then a discount of 10% might apply for that month. If a score of 90 is achieved for the same period a discount of 15% might apply. Any combination of discounts or surcharges, bonuses and other incentives can be used. For example users who score over 90 for the whole year might be entered into a drawing to get free tolls for the last or following year. Other incentives like free Saturday parking or the like could also be provided for achievement of specific safety scores. Surcharges could also apply for poor scores, though this may not always be preferred from a marketing standpoint.

In offering the ability to obtain discounts for toll, HOT, road pricing, public agencies will have a new public policy tool to promote safety on the nation's toll roads and freeways.

To insure that individual drivers are being tracked properly, the invention optionally includes ways to identify the driver to the vehicle OBU or central monitoring facility. For example, a driver might identify himself as the driver of the vehicle for specific period by using a smart phone application or text message. This allows the invention to work on vehicles where more than one driver uses a particular vehicle and where we want to generate individual report cards on the driver. Implementation could be as simple as having a driver enter the vehicle and press a single icon on his smart phone. The phone in turn automatically sends an SMS or other type of message over the network identifying the driver, along with GPS coordinates from the smart phone. The vehicle can be identified by automatically matching the GPS coordinates of the phone to the GPS coordinates on the OBU, thus matching the driver to the vehicle for the purpose of collecting driver performance data in developing the score card. Alternatively, driver identification could be achieved over the blue tooth, Wi-Fi or other local wireless connection supported by the phone provided by providing the matching connection in the OBU as well.

The transfer of payments, discounts, incentives, surcharges and the like can be applied either on the basis of the report card for the vehicle, for the individual driver, or for any combination thereof.

The individual continues to be identified with the vehicle until turned off by the user, or GPS disassociates the vehicle and driver, or automatically when the engine goes off as indicated on the OBD port.

In a further embodiment DMV registration fees are adjusted for a driver license or vehicle plate number according to driver safety scores, or based on score improvement. Alternatively, teen drivers who have provisional or graduated licenses may be required to maintain a certain driver safety score to maintain those privileges or to graduate to new privileges. For examples drivers may be restricted from driving past 11:00 pm, but that may be extended to midnight if certain scores levels are maintained relative to the peer group. Similarly, drivers who have their licenses suspended can have the return of their driving privileges contingent on achievement of a driving safety score, or improvement in score.

Other areas of applicability include regional taxi fleets. Monitoring devices can be mounted in taxi cabs for the purpose of scoring the drivers safety behavior. Such scores can be published to inform the public, or used by good scoring drivers/companies to promote their services. Public agencies may mandate minimum scores as a condition of licensure or to obtain privileges such as access to airport facilities.

Many airports operate Ground Transportation Management Systems (GTMS) that control and manage access of commercial vehicles (vans, taxis, courtesy buses) to airport terminals, frequently scuh vehicles pay fees to access the facilities and GTMS systems collect such fees in conjunction with RFID system in most cases, However the system of the invention can be utilized in a manner similar to that described for GPS Tolling applications to collect fees from vehicles and to control access for vehicles to certain locations. These devices can also be used to monitor “short trips” that are considered too short to justify the wait through the taxi queue at the airport. When drivers make a “short trip” such as an airport hotel they are often allowed to use the “short queue” to allow them to get a new airport fare faster, thus offsetting the lost time for a smaller fare. The device of the invention can be used to automatically monitor these “short trips” and determine if access to the “short trip queue” is warranted. In addition taxi driver safety performance can be monitored as above and incentives given for good or improved safety scores, such as reduced rates for access to the airport of bonus allowances of access to the short trip queue. For example if a driver achieves a score of 90 or above, the driver may be awarded 10 bonus accesses per period of time (for example a month) to the short trip queue, but 85 and above only 5 bonus trips, those below that get no bonus trips. This type of incentive is effective to giving drivers an economic incentive to have high scores, as additional trips resulting from shorter wait times means more fares.

A variation on the HOT and Toll applications described herein is an application of the invention to facilitate mileage-based user charging. In this instance, the OBU accumulates the total miles traveled by the vehicle so that this data can be sent periodically (for example: daily, weekly, monthly, quarterly or yearly) to the service center to compute a Vehicle Mileage Tax (VMT) associated with the use of the vehicle on public roadways. VMT is of interest to some jurisdictions as alternative or supplementary revenue source to the gas tax, such revenues usually dedicated to funding construction and maintenance of transportation infrastructure. In such a system it is likely that tax is only due for roadway use within a certain jurisdiction such as a particular state. This can be achieved by using a GPS receiver to provide periodic (example: every second) vehicle position input data to a processor that can calculate the total miles traveled based on this data feed and retain this calculated mileage encrypted in a secure memory location within the OBU. Periodically, this data is uploaded over the common carrier data link to the service center from the OBU. Because this is a very small amount of data, the data usage over the common carrier data network is very small, and the associated cost therefore very low.

Similar to the polygons used to define TMP's described above, polygons can also define the geographical jurisdiction or jurisdictions in which the VMT is to be collected. The OBU keeps track of entry and exit into the various polygons defining those jurisdictions based upon the GPS data, and collects mileage totals in bins related to each of the jurisdictions. In this way, the proper VMT rates can be applied to the mileage accrued in each of the participating jurisdictions. For example, mileage in state A may be taxed at 2 cents per mile, while mileage accrued for state B might be charged 3.5 cents per mile. Furthermore, there may be a transitional period where fuel taxes continue to be charged while VMT is collected. Policy makers may opt to refund part or all or fuel taxes paid by those paying VMT. The amount of fuel tax paid by those users can be determined by direct means, for example, paper or electronic records of fuel purchase can be collected and accounted for the purpose of calculating a fuel tax refund. This process can be labor intensive and inconvenient. As an alternative, the OBU can provide data to allow for a sufficiently accurate estimate of fuel usage for the purpose of calculating the fuel tax refund. Fuel usage per mile (fuel economy) is estimated and multiplied by the number of miles driven. Fuel economy is dependent on the following major factors: the vehicle characteristics, how “hard” the vehicle is driven, and the speed profile the vehicle is operated over. Other factors such as weight variation, terrain characteristics and vehicle maintenance may factor in fuel economy but typically contribute less variation to fuel economy than the former factors, particularly when averaged over many miles and trips. As discussed above, driving characteristics can be monitored to determine a driving score which provides a good estimate of the factor related to hard driving. The general characteristics of the vehicle (typical fuel consumption) is known based on manufacturer data. A profile of operating speed can be recorded by maintaining summary records of the total number of miles driven in speed buckets. The first bucket would be to record total time idling, then number of miles driven 0-5 mph, 5-10 mph and so on through say to 95-100 mph. When vehicle mileage for a given jurisdiction is reported, the corresponding factors for hard driving (rapid accelerations and decelerations) plus the speed profile are also sent to the service center. This data is then factored with the vehicle type to estimate the overall fuel economy and multiplied by the mileage driven subject to VMT and therefore eligible for fuel tax refund to determine the total refund due for the applicable period, While this method of calculating fuel usage subject to tax refund may be less precise than collecting actual purchase records, tax jurisdictions and users may find this type of estimate acceptable due to the convenience of the automatic calculation.

It may also be desirable to provide an optional OBU to users that does not include GPS functionality. This provides an acceptable option to users with concerns about potentially being tracked by GPS based OBU. As an alternative, odometer data input to the OBU can be used to calculate the miles traveled during a particular period. This has the disadvantage that miles traveled in jurisdictions that do not have VMT or a different rate cannot be differentiated. To address this problem, battery powered RF beacons can be placed proximate to the roads at jurisdiction border locations and their communication zones directed to cover the relevant roadways so that they can communicate with the OBU over its built in wireless link. The beacons will communicate with the OBU over the low power RF link supported by the OBU so that the OBU can determine that the vehicle is crossing the border. Typically two beacons are used so that the OBU can determine from the sequence of the beacon detection whether the vehicle is entering or exiting a particular jurisdiction. This information is then recorded to allow for mileage data to be collected in bins associated with those jurisdictions. Using the same low power low duty cycle design concept described for the DIM, it is well understood in the art that a beacon can be designed to operate for many years on relatively small primary batteries, thus making the installation of beacons inexpensive and simple and low maintenance, even if required at a relatively large numbers of sites where jurisdiction crossings occur.

In addition, the beacon approach can be used to calibrate the odometer data received from the OBD port on the vehicle. This is useful because raw odometer data can vary with tire wear, inflation and other vehicle conditions. In addition to jurisdiction crossing locations, beacons can be located at high traffic locations and separated by a known distance. In the time between readings distance can be compared to the data received from the OBD port and used to calibrate the output from the port.

While certain representative embodiments and details have been shown for purposes of illustrating the invention, it will be apparent to those skilled in the art that various changes in the methods and apparatus disclosed herein many be made without departing from the scope of the invention.

1. A system for the collection of vehicle tolls by a tolling authority, comprising:
an on-board unit comprising a
GPS receiver; and
a transceiver adapted to communicate with a common carrier;
wherein said GPS receiver establishes a location of the vehicle and said transceiver transmits said location to the tolling authority via said common carrier.

2. The system of claim 1, further comprising:
a user interface comprising a user input,
wherein said user input is adapted to receive user data and said user data is transmitted to the tolling authority by said transceiver.

3. The system of claim 1, further comprising:
a user interface comprising a display, wherein said display receives information from the tolling authority via said transceiver.

4. The system of claim 1, further comprising:
a user interface comprising a user input and a display
wherein said user input is adapted to receive user data and said user data is transmitted to the tolling authority by said transceiver and said display receives information from the tolling authority via signals received by said transceiver.

5. The system of claim 4, wherein said user interface is housed separately from said on-board unit, and wherein said on-board unit is powered by the vehicle and said user interface is not powered by the vehicle.

6. The system of claim 5, wherein said user interface communicates with the on-board unit wirelessly.

7. The system of claim 6, wherein said user interface is a smart phone.

8. The system of claim 4, wherein the transceiver receives data sent by the tolling authority when the vehicle is approaching an upcoming toll threshold, said data including a toll cost to be levied upon crossing said toll threshold and wherein said toll cost is displayed on said user interface display.

9. The system of claim 1, wherein said transceiver transmits to the tolling authority a unique identifier.

10. The system of claim 9, wherein said unique identifier is linked to a vehicle license plate number or a vehicle identification number (VIN).

11. The system of claim 1, further comprising a second transmitter, said second transmitter transmitting a vehicle license plate number or YIN

12. A system for the collection of roadway tolls by a tolling authority for vehicle traveling along a toll road, comprising:
an on-board unit comprising
a GPS receiver; and
a user interface comprising
a user input;
a display; and
a transceiver adapted to communicate with a common carrier;
wherein said GPS receiver establishes a location of the vehicle and said transceiver transmits said location to the tolling authority via said common carrier.

13. The system of claim 12, wherein said user interface comprises a smart phone and wherein said smart phone communicates with said GPS receiver wirelessly to receive said vehicle location.

14. The system of claim 13, wherein said display is separate from said smart phone and said smart phone transmits information to said display wirelessly.

15. A method for collecting roadway tolls for a vehicle traveling along a designated portion of roadway comprising:
computing a vehicle location from GPS data;
transmitting said vehicle location and user identification data to a tolling authority via a common carrier; and
assessing a toll charge for the vehicle based on said vehicle location.

16. The method of claim 15, further comprising:
transmitting a vehicle occupancy level to said tolling authority; and
assessing said toll charge based on said vehicle location and said occupancy level.

17. The method of claim 15, further comprising:
transmitting to an in-vehicle display a projected toll charge prior to the vehicle reaching a toll threshold location.

18. The method of claim 15, further comprising:
transmitting from said vehicle a license plate number over a local wireless link;
receiving said license plate number; and
comparing said received license plate number with a visually observed license plate number.

19. The method of claim 15, further comprising:
storing a plurality of vehicle locations and
transmitting said plurality of stored vehicle locations at one time to said tolling authority.
